(19) United States
(12) Patent Application Publication
(10) Pub. No.: US 2013/0278698 A1
(43) Pub. Date: Oct. 24, 2013

(54) TRAY, INK JET TEXTILE PRINTING APPARATUS, AND MANUFACTURING METHOD OF PRINTED MATTER

(71) Applicant: SEIKO EPSON CORPORATION, Tokyo (JP)

(72) Inventors: Hideyuki TAKEUCHI, Shiojiri-shi (JP); Nobuhiko Hamada, Shiojiri-shi (JP)

(73) Assignee: SEIKO EPSON CORPORATION, Tokyo (JP)

(21) Appl. No.: 13/835,336

(22) Filed: Mar. 15, 2013

(30) Foreign Application Priority Data
Apr. 24, 2012 (JP) 2012-098464

(51) Int. Cl. B41J 13/10

(52) U.S. Cl. CPC B41J 13/10
USPC 347/104

(57) ABSTRACT

A tray is provided so as to be detachable from a support unit of an ink jet textile printing apparatus. The tray includes a main body having a setting surface on which a material to be printed is set, a first protrusion portion which is used when arranging the main body at the support unit is provided at an opposite side to the setting surface in a protruding manner, and at least two grip portions are provided at side of the main body opposite to the setting surface. The grip portions are separated from each other.

### CROSS-REFERENCE TO RELATED APPLICATIONS

The entire disclosure of Japanese Patent Application No. 2012-098464, filed Apr. 24, 2012 is expressly incorporated by reference herein.

### BACKGROUND

1. Technical Field

Embodiments of the present invention relate to a tray in which a material such as a fabric is set in preparation for printing on the material set in the tray, ink jet textile printing apparatus including the tray, and method for manufacturing printed matter.

2. Related Art

In the related art, an ink jet textile printing apparatus prints a desired image on the surface of a material or fabric such as a T-shirt by ejecting ink of each color from an ink ejecting head to the surface of the material.

When setting a material in preparation for printing on the material, a tray is used to set the material. The tray is supported by a transporting unit that can transport the tray and the material set in the tray towards a textile printing execution region. An ink ejecting head is present in the textile printing execution region.

In the tray, a long axis portion for positioning and fixing is provided with respect to a support unit of the transporting unit so as to protrude to the side of the support unit as disclosed in JP-A-2004-284305 which is described below.

When the tray is configured so as to be detachable from the support unit of the ink jet textile printing apparatus, a material to be printed is set in the tray in a separate work area by detaching the tray from the support unit. In addition, it is common that the tray, which is in a state in which the material to be printed is set, is carried by hand to a place of the support unit of the ink jet textile printing apparatus and is mounted on the support unit.

However, when the tray, which in a state of being set with the material to be printed, is carried using hands, the material to be printed which is set along with the tray is directly grasped by hands. For this reason, a set state of the material to be printed is changed before and after being carried. There is a concern that the set state of the material to be printed may be broken or changed.

In addition, when the long axis portion for positioning is provided in the tray, it is difficult to horizontally place the tray because the tray is disturbed by the long axis portion even when attempting to place the tray on a flat table by detaching the tray from the support unit.

### SUMMARY

An advantage of some aspects of the invention is that it is possible to reduce concerns related to a change in the set state of a material to be printed when the material is set in a tray by hand. There is a concern that a set state of a material to be printed may be changed before and after carrying when carrying a tray in a state in which the material to be printed is set by hand and aspects of the invention can reduce these concerns.

In addition, it is possible to improve efficiency when performing a setting work. More specifically, it is possible to improve efficiency when setting a material to be printed in a tray of an ink jet textile printing apparatus.

According to a one aspect of the invention, a tray is provided and is configured to be detachable from a support unit of an ink jet textile printing apparatus. The tray includes a main body having a setting surface on which a material to be printed is set or placed, a first protrusion portion which is used when arranging the main body at the support unit. The first protrusion portion is provided in a protruding manner at an opposite side of the main body with respect to the setting surface. The tray may also include at least two grip portions that are separated from each other and that are provided at the opposite side to the setting surface.

In one example, “material to be printed” means a “fabric” as a printing target. The material to be printed may include natural fibers such as cotton, silk, and wool, chemical fibers such as nylon, textile of composite fibers in which these are mixed, knitted fabrics, non-woven fabrics, or the like, and includes both of a long material which is wound in a roll shape and a material which is cut in the predetermined length. The material to be printed may include, by way of further example, a fabric or the like before and/or after cutting. The material to be printed may be in parts that are not sewn together. Clothes that have been sewn such as a T-shirt are also examples of a material to be printed. Other materials to be printed include, but are not limited to other articles such as a handkerchief, a scarf, a towel, a curtain, a sheet, and a bed cover before or after sewing or the like.

In addition, “being provided by protruding to the opposite side to the setting surface” includes, by way of example, a structure of protruding to the same direction as the protruding direction of the first protrusion unit from the opposite side surface to the setting surface of the main body, and a structure of protruding to the same direction as the protruding direction of the first protrusion unit from the side surface of the main body. In other words, a protruding structure protrudes from a side that is opposite of the setting surface.

According to one aspect of the invention, it is possible to carry the tray by holding two grip portions using both hands. Accordingly, when carrying the tray which is in a state of being set with the material to be printed using hands, the grip portions are gripped. It is not necessary to directly hold the material to be printed using hands. Due to this, a force which breaks the set state of the material to be printed does not directly act on the set material, and it is possible to reduce concerns that the set state of the material to be printed will be changed before and after carrying the tray.

In the tray, the grip portions may be provided at least at two end portions of the main body which are facing each other.

According to the aspect of the invention, since a pair of grip portions is provided, for example, on two side end portions (e.g., left and right sides of a rectangular main body), the tray in a set state can be easily held using both hands, and it is possible to improve the workability of a worker in a setting operation. The grip portions help ensure that the material, once set in the tray, is not changed or disturbed by the worker because the worker can carry the tray using the grips.

In the tray, a frame is provided. The frame can be fitted into the main body in a state in which the material to be printed is set on the setting surface. The frame maintains the set state of the material to be printed. In the tray, the grip portion protrudes in a protruding dimension based on a mounting surface on a side which is opposite to the setting surface and the grip portion may have a length which exceeds a range in which the frame in the fitted state is present in the protruding direction.

According to one aspect of the invention, the protruding dimension of the grip portion based on the mounting surface on the side which is opposite to the setting surface is the length which exceeds the range in which the frame in the fitted state is present in the protruding direction. In other words, the protruding dimension of the grip portion, which protrudes from the mounting surface, exceeds the amount in which the frame protrudes in the protruding direction. Accordingly, it is possible to prevent only the frame from being held up by hands, which acts first on the lower surface of the frame when holding up the tray to which an insertion-type frame is attached. In this manner, it is possible to prevent a positional deviation of the material to be printed which is set at a predetermined setting position using the frame, that is, breaking of the set state. The grip portions effectively ensure that a user does not grasp the frame when carrying the tray and ensure that the set position of the material to be printed is undisturbed or unchanged.

In the tray, a leg portion is provided on a side which is opposite to the setting surface of the main body in a protruding manner. A protruding dimension of the leg portion is longer than that of the first protrusion portion. A gap which allows hands to be put in is present at a lower part of the grip portion in a state of raising the main body using the leg portion. The leg portions ensure that a space is present that allows the grip portions to be grasped by a user's hands and the leg portions are configured to raise the main body, for example with respect to a planar surface such that the space is present.

According to the aspect of the invention, since the main body of the tray includes the leg portion whose protruding dimension is longer than that of the first protrusion portion, it is possible to detach the tray from the support unit of the ink jet textile printing apparatus, and to horizontally place the tray on a planar portion of, for example, a desk, or the like. In this manner, a setting work of setting the material to be printed to or in the tray of the ink jet textile printing apparatus becomes easy, and it is possible to improve workability in the setting work.

In addition, since the gap or space which allows hands to be put in is present at a lower part of the grip portion in the state of raising the main body using the leg portion or because the main body is raised due to the configuration of the leg portion, an operation of holding the grip portion using hands after setting the material becomes easy due to the presence of the gap of space, and the workability is improved.

In addition, it is possible to perform the work of setting the material to be printed into the tray in a separate place or a location that is separated from the apparatus main body by detaching the tray from the apparatus main body of the ink jet textile printing apparatus.

In addition to this, when a plurality of trays are prepared, and the materials to be printed are set in the trays in advance, it is possible to omit the setting work of the material to be printed in a setting area which has been performed every time printing is finished, and to perform the setting work, and the printing of the material to be printed efficiently.

In the tray, according to the aspect of the invention, the grip portion and the leg portion may be integrally formed.

According to the aspect of the invention, by integrally forming the grip portion and the leg portion, that is, by forming an integrated leg portion unit, it is possible to realize a reduction in the number of components. It is possible to perform a detaching work of the grip portion and the leg portion, or an adjusting work of an attaching position with small number of processes. For example, the leg portion unit can be adjusted to another attaching position or changed for a different sized leg portion unit.

In addition, it is possible for various sizes of the leg portion units to correspond to main bodies by configuring the attaching position of the leg portion unit so as to be variable by being set to a position at which the leg portion unit is linked to the other leg portion unit, to a position at which the leg portion unit goes away from the other leg portion unit, or to a position at which the leg portion units are overlapped with each other. In other words, the attaching positions of the leg portion units can be changed to accommodate differently sized trays.

In addition, according to the aspect of the invention, it is possible to store the leg portion unit in a state of being detached from the main body when the tray is not used. In this manner, when the tray is stored in a state the leg portion unit is detached, it is possible to further improve a storing efficiency of the tray, and to reduce a concern that the separate grip portion and leg portion may be lost when configuring the grip portion and the leg portion as a single structure of a separate body.

According to a an aspect of the invention, there is provided an ink jet textile printing apparatus which includes a tray, a support unit at which or from which the tray is detachably provided, and a printing unit which ejects ink to a material to be printed which is set in the tray.

A manufacturing method of a printed matter is provided and which includes setting a material to be printed on the setting surface in a state in which the tray according to the above described aspect is raised using the leg portion. The tray is detached from a support unit of an ink jet textile printing apparatus when setting the material and is made to stand, subsequently carrying the tray by holding grip portions of the tray using hands, arranging the tray at the support unit, and executing printing.

In the method, it is possible to manufacture many materials to be printed efficiently. It is possible to print on many material that are set on trays as disclosed herein.

### BRIEF DESCRIPTION OF THE DRAWINGS

Embodiments of the invention will be described with reference to the accompanying drawings, wherein like numbers reference like elements.

FIG. 1 is a perspective view which illustrates a schematic configuration of an ink jet textile printing apparatus on which an example of a tray is mounted.

FIG. 2 is a cross-sectional side view which illustrates a schematic configuration of the ink jet textile printing apparatus on which the tray is mounted.

FIG. 3 is an exploded perspective view which illustrates an attaching attachment, and the tray according to embodiments of the invention.

FIG. 4 is a perspective view which illustrates the tray obliquely from below.

FIG. 5 is a perspective view which illustrates the attaching attachment obliquely from below.

FIG. 6 is a cross-sectional side view which illustrates a state in which the tray is horizontally placed on a planar portion.

FIGS. 7A, 7B, and 7C are bottom views which illustrate attaching states of a leg portion unit in the tray.

FIG. 8 is a perspective view which illustrates another example of a tray.

FIG. 9 is a cross-sectional side view which illustrates a state in which trays are piled up.

FIG. 10 is a perspective view which illustrates another example of a tray.

### DESCRIPTION OF EXEMPLARY EMBODIMENTS

Embodiments of the invention relate to an ink jet textile printing apparatus and to a tray used in the ink jet textile printing apparatus. A schematic entire configuration of an ink jet textile printing apparatus according to embodiments of the invention will be describe. Configurations and operations of the tray will also be described.

In the following description, a fabric such as T-shirt is an example of a material to be printed. One of skill in the art can appreciate that other materials and fabrics may be set in the tray of the ink jet textile printing apparatus. The T-shirt (hereinafter, also referred to as “fabric”) T, has body portion Ta, and a sleeve portion(s) Tb are sewed into a tubular shape in one example. In the following description, the front surface side on which a printing image G is formed on the T-shirt is set as a first surface 9, and a supported surface on the rear side which is opposite to the first surface 9 is set as a second surface 11.

An ink jet textile printing apparatus 1 is an apparatus which prints or performs a printing operation using an ink jet method. The ink jet textile printing apparatus 1 includes a tray 3 in which a material T, on which an image is to be printed, is set. The ink jet textile printing apparatus 1 includes an attachment unit 47 which is used for detachably attaching the tray 3 to a support unit 31 of an apparatus main body 2. The ink jet textile printing apparatus is configured by including the tray 3, and the attachment unit 47 separately from the tray 3.

In addition to the tray 3 and the attachment unit 47, the ink jet textile printing apparatus 1 includes members which configure a transport unit 17 and members which configure a printing unit 19. The transport unit 17 transports the material to be printed T which is set on the tray 3 along the transport direction A. The printing unit executes printing or performs a printing operation by ejecting ink of various colors on the first surface 9 of the material to be printed T which is guided to a printing executing region 15 by the transport unit 17.

The transport unit 17 includes a support base 29 which extends along the transport direction A, a slider 30 which reciprocates along the transport direction A at the upper part of the support base 29, for example, at a center portion in the width direction B. The transport unit 17 also includes the support unit 31 which is raised upward by being mounted on the slider 30, a timing belt 43 which drives the slider 30, a motor which drives the timing belt 43 (not shown), and a guide rod 45 which guides a movement of the slider 30 in the transport direction A.

At the upper part of the support unit 31, the attachment unit 47, which will be described later, is provided through a connection mechanism 33. In other words, the attachment unit 47 is connected to the connection mechanism 33. The tray 3, which will be described later, is detachably mounted thereon through the attachment unit 47. The tray 3 is detachably mounted to the attachment unit 47.

The printing unit 19 includes a carriage 21 which reciprocates in the width direction B of the apparatus main body 2 which intersects the transport direction A of the material to be printed T, as the movement direction, and an ink ejecting head 13 which is mounted on the carriage 21. The printing unit 19 executes printing or performs a printing process by ejecting ink of various colors toward the first surface 9 of the material to be printed T which is present or located in the printing executing region 15.

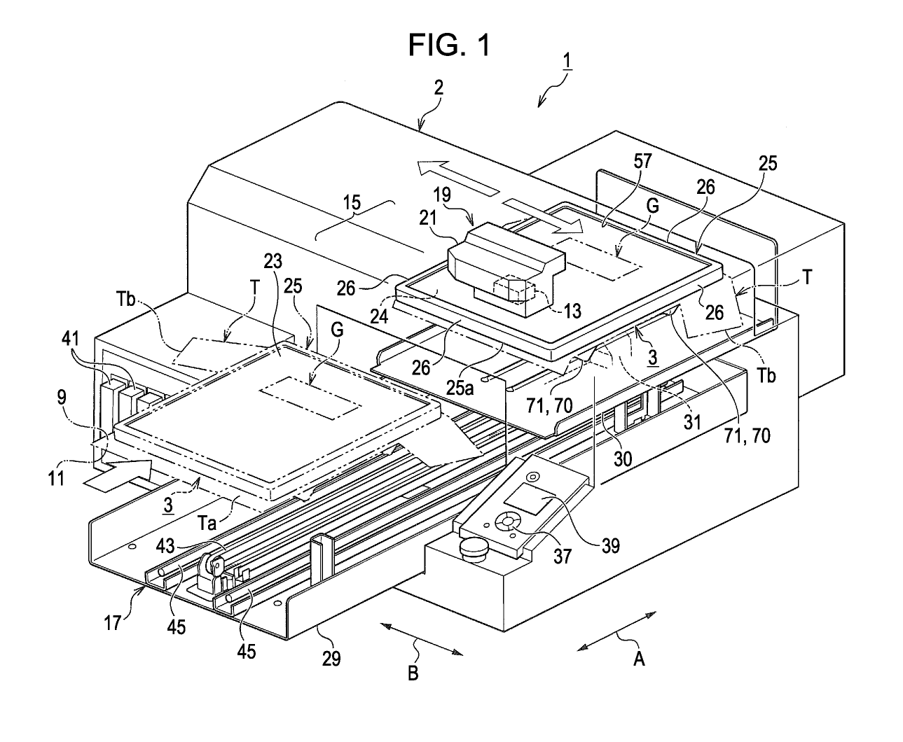

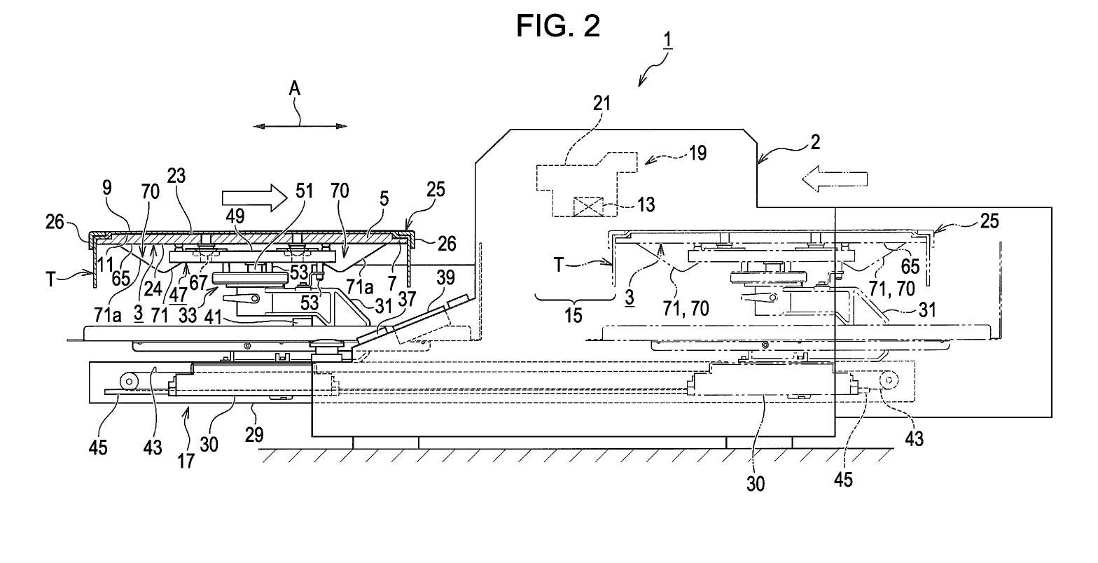

An ink cartridge 41 may be a constituent member of the above described printing unit 19. The ink cartridge 41 supplies ink of various colors to the ink ejecting head 13 through an ink tube. The ink cartridge 41 is provided on the left side (FIG. 1) of the apparatus main body 2 when viewed from the front.

In FIG. 1, an operation button 37 which execute various operations of the ink jet textile printing apparatus 1, and a display unit 39 which displays setting information relating to the ink jet printing, or various messages, are provided on the right side of the apparatus main body 2 when viewed from the front.

A tray 3A) includes a main body 65. The material to be printed T is set in a setting surface 23 of the main body 65. A positioning pin 67, which is a first protrusion portion, is provided at a mounting surface 24. The mounting surface 24 is on an opposite side of the tray 3A with respect to the setting surface 23 in a protruding manner. The positioning pin 67 is used when mounting the main body 65 to the support unit 31. At least two grip portions 73 are provided at an end edge portion of the mounting surface of the main body, and are separated from each other.

A leg portion 71 may be provided at the mounting surface 24 of the main body 65 in a protruding manner. A protruding dimension of the leg portion 71 is longer than that of the positioning pin 67, and the grip portion 73 and the leg portion 71 are integrally formed.

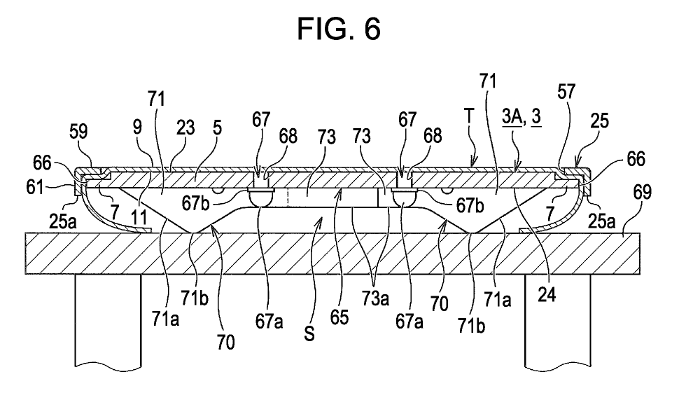

The leg portion 71 of the tray 3A horizontally supports the main body 65 in a state in which a tip end 67a of the positioning pin 67 does not come into contact with a planar portion 69, for example when the main body 65 is horizontally placed on the planar portion 69 (FIG. 6) such as a desk. A gap S where a hand enters is present at the lower part of the grip portion 73 in a state in which the main body 65 is raised by the leg portion 71. The tray 3A is detachably provided with respect to the support unit 31 of the apparatus main body 2.

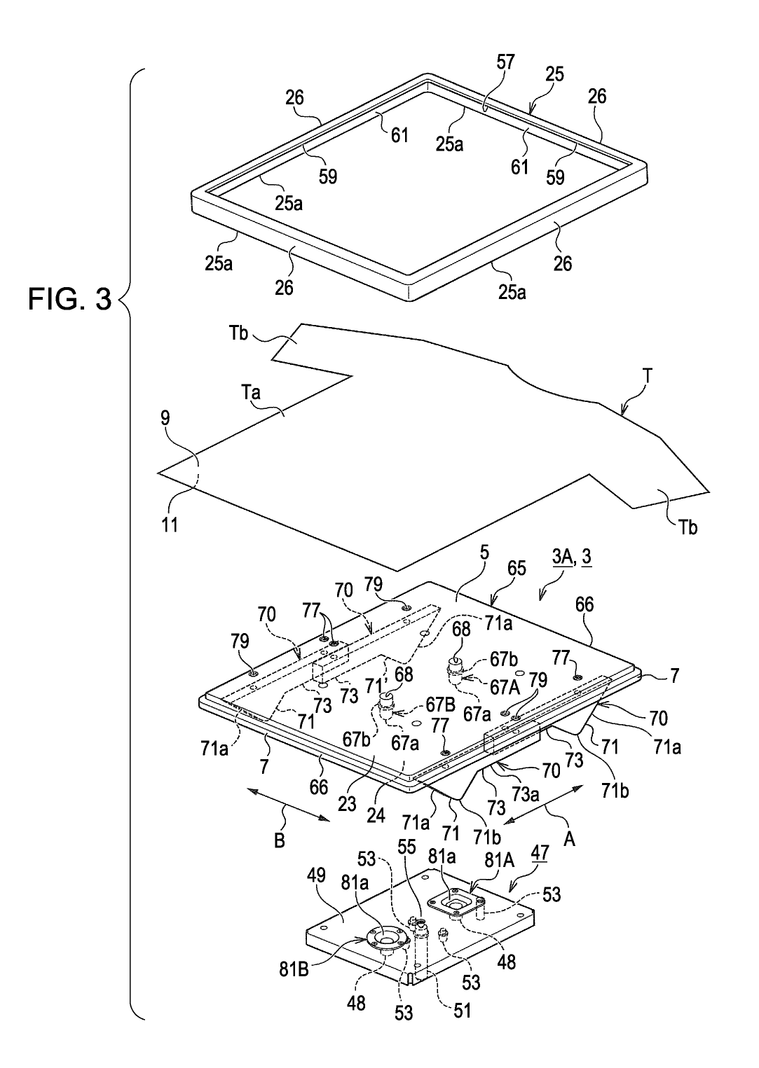

In addition, as illustrated in FIG. 3, the main body 65 is a member which is formed in a rectangular flat shape. Corner portions of the rectangular flat shape of the main body 65 are processed to be rounded. The main body 65 includes four peripheral sides and the peripheral sides are formed with an edge portion 7. The edge portion 7 is formed to be thinner than a main body portion 5 at the center, and is formed in an outer flange shape which is projected to the outside in the horizontal direction. A top face of the main body portion 5 of the main body 65 is the setting surface 23. The second surface 11 of the material to be printed T is supported from below by the setting surface 23, and the lower surface of the main body portion 5, which is opposite the setting surface 23, is the mounting surface 24 on which the attachment unit 47 which will be described later is mounted.

In addition, the tray 3A is configured such that the edge portion 7 of the main body 65 is attached with or inserted into a fitted-in frame 25 as illustrated in FIG. 3 in order to fix the material to be printed T on the main body 65 in a state in which the material to be printed is positioned at a predetermine set position.

A window portion 57, which may be square shaped, to which the main body portion 5 of the main body 65 is fitted is formed in the frame 25. That is, the frame 25 is configured by a member having a rectangular frame shape. Four peripheral sides of the frame shape of the window portion 57 are surrounded by four frame elements 26 having L-shaped cross sections. In other words, the window portion 57 is bounded by the frame elements 26, which have L-shaped cross sections.

The four frame elements 26 may include a step portion 59 having an inner flange shape which faces the top face of the edge portion 7 of the above described main body 65, and a side plate portion 61 which faces the side surface of the edge portion 7 of the above described main body 65.

In addition, two holes 68 for attaching the positioning pin 67 which will be described later are formed at the center of the main body 65. In the vicinity of two sides of the main body 65 on left and right sides in the width direction B, attaching holes 77 (which are used when attaching the leg portion unit 70 which will be described later) are formed by 4, in one example, on each of the left and right sides and are arranged in two lines.

The leg portion unit 70 in FIG. 3 is in a state in which the unit is not attached to the main body 65.

The positioning pin 67 which is provided with respect to the mounting surface 24 of the main body 65 includes a shaft member. The tip end 67a of the positioning pin 67 has a circular cross-sectional shape which has been processed in a spherical shape so as to be rounded, and of which a diameter is thick.

In addition, the outer flange portion 67b is formed in the middle of the positioning pin 67, and a portion on the base end side from the outer flange portion 67b is embedded in the hole 68 which is formed at the center of the main body 65. In addition, the outer flange portion 67b may not be provided.

The leg portion 71 is configured to include a flat member having a triangular shape when viewed from the side, and is located at the inner side of one end edge portion 66 of the main body 65. In addition, the leg portion 71 has an inclined surface 71a which retreats toward the inside from the end edge portion 66 of the main body 65. That is, the outer surface of the leg portion 71 becomes the inclined surface 71a which is able to guide a movement of the material to be printed T which is mounted from the end edge portion 66.

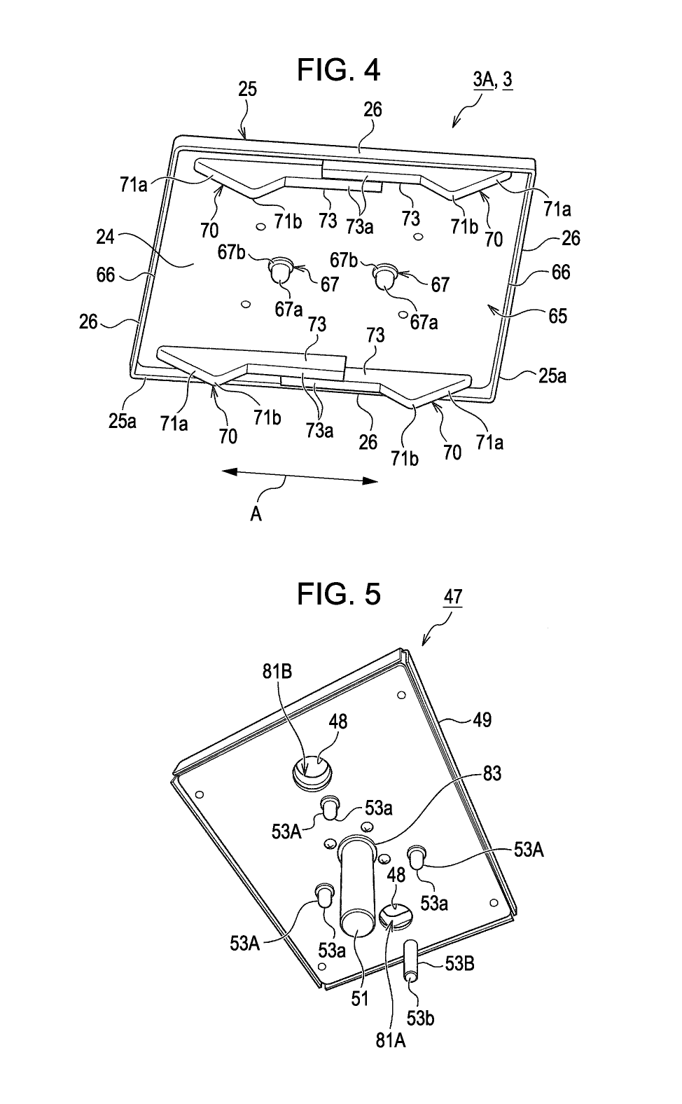

As illustrated in FIGS. 4 and 6, since the inclined surfaces 71a are provided at antero-posterior sides in the tray movement direction, it is possible to obtain an effect of reducing influence of air when moving, compared to a structure which vertically extends in the vertical direction.

The leg portion 71 is provided between the end portion 66 and the positioning pin 67 in the tray moving direction (transport direction A).

In addition, a square bar-shaped member is formed in the leg portion. The bar-shaped member extends toward the inside from the inner inclined surface of the leg portion 71, and the square bar-shaped member is configured so as to function as a grip portion 73 which is gripped by a user when the user carries the tray 3A using hands.

As illustrated in FIGS. 3 and 4, according to the embodiment, the grip portion 73 is provided at least at two end edge portions of the main body 65 which are facing each other. That is, the main body 65 has a rectangular shape, and is provided with a pair of grip portions 73 and 73 at two side end edge portion on the left and right sides of the main body 65 in one example. Due to this, the tray 3A in the set state can be easily taken or carried using both hands, and workability of a setting operation by a worker is improved. In other words, it becomes easier for a worker to set a material in the tray 3A and to carry the tray 3A once the material is set in the tray 3A.

In addition, as illustrated in FIG. 6, in a state in which the tray 3A is horizontally placed on the planar portion 69 such as a desk, the space S where hands of a worker enter is formed between the grip portion 73 and the planar portion 69. The leg portion 71 protrude in a protruding direction further than the bar-shaped member, which enables the space S to be present when the tray is horizontally placed on a surface.

In addition, in the state in which the tray 3A, which is attached to the fixing frame 25, is horizontally placed on the planar portion 69, a base 73a of the grip portion 73 is located at the planar portion 69 side (vertically lower side) of a base 25a of the fixing frame 25.

A screw aperture is provided on the top face side of the leg portion unit 70. The leg portion 71 and the grip portion 73 are integrally formed in the leg portion unit 70. The screw aperture is screwed with a fixing screw 79 which is inserted from the upper part of the attaching hole 77 which is formed in the vicinity of two sides on the left and right of the above described main body 65 in the width direction B, and four sets of the leg portion unit 70 are attached to a predetermined position of the mounting surface 24 of the main body 65 in bilateral symmetry. Fixing screws are inserted through the attaching hole 77 and into the screw apertures to secure the leg portion unit 70 to the mounting surface of the main body 65.

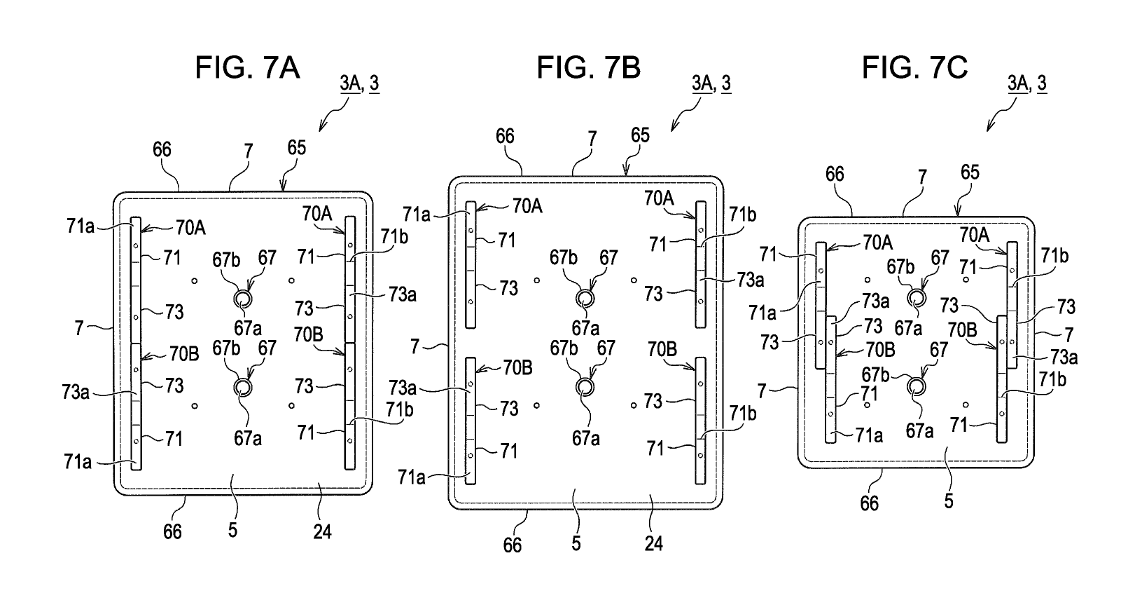

The attaching position of the leg portion unit 70 with respect to the mounting surface 24 of the main body 65 can be appropriately changed to attaching modes which are illustrated in FIGS. 7A, 7B, and 7C. The attaching holes 77 can be arranged in different configurations and the leg portion unit 70 can be arranged in different attaching modes.

FIG. 7A illustrates an attaching mode in which, in a state in which the tray 3A is mounted on the support unit 31, a leg portion unit 70A which is arranged at the front side as a side to which a worker has access, and a unit 70B which is arranged at the rear side are connected in the tray 3A.

FIG. 7B illustrates an attaching mode in which the leg portion unit 70A, which is arranged at the front side, and a leg portion unit 70B, which is arranged at the rear side, are separated. Here, the “connected” means that at least a part of an end portion of the leg portion unit 70A on the rear side comes into contact with at least a part of an end portion of the leg portion unit 70B on the front side. In FIG. 7A, the leg portion unit 70A is connected to the leg portion unit 70B.

In addition, FIG. 7C illustrates an attaching mode in which a part of the leg portion unit 70A, which is arranged at the front side, overlaps with a part of the leg portion unit 70B, which is arranged at the rear side. It is possible to appropriately select these attaching modes by switching thereof according to a size or the like of the main body 65 to be used.

In FIGS. 7A, 7B, and 7C, the positioning pin 67 and the grip portion 73 are arranged to overlap with each other in the width direction. In addition, at least a part thereof may overlap with each other. In this manner, it is possible to reduce a concern that user's hands, or that a printed matter may come into contact with the positioning pin 67. The grip portion 73 functions as a bulwark.

It is also possible to use two leg portions of different sizes. For example, leg portions of different sizes may be used on one side with respect to the plurality of trays of which sizes are different. In one example, the length of the leg portion unit 70 (one leg portion 71 and one grip portion 73) in the front-back direction (transport direction A) as the first direction is the length of a minimum-sized tray or less in the front-back direction, and the shortest distance between positioning pin 67 and the end portion 66 in a maximum-sized tray, or more.

Due to this, it is easy to use the leg portion unit, since the leg portion unit 70 (one leg portion 71 and one grip portion 73) does not protrude from the minimum-sized tray (first tray) in the first direction. In addition, it is possible to reduce a concern that user's hands, or that the printed matter may come into contact with the positioning pin 67, since the positioning pin 67 is in a state of being covered with the leg portion unit 70 (one leg portion 71 and one grip portion 73).

In addition, the shortest distance is the shortest distance in the front-back direction (transport direction A) between the positioning pin 67 and the end portion 66 which is closest from each positioning pin 67 in the front-back direction (transport direction A). The distance may be a distance from the center of the positioning pin 67, or may be a distance from a portion which is the farthest from a point of the end portion 66 as a target between the positioning pin 67 and the outer flange portion 67b.

A shape of the main body 65 of the tray 3 is not limited to the rectangular shape which is illustrated in the embodiment. It is also possible for the main body 65 to have another shape such as a pentagon shape, a hexagon shape, a heptagon shape, an octagon shape, or the like.

In addition, as illustrated in FIG. 5, the attachment unit 47 which is used for attaching the tray 3 to the support unit 31 of the apparatus main body 2 includes an attaching plate 49 which has a hole 48 to be fitted with the positioning pin 67 of the tray 3, and a positioning shaft portion 51 which protrudes to the support unit 31 side of the apparatus main body 2 from a center of the attaching plate 49. The hole 48 are configured to removably receive the positioning pin 67 in one example and may be configured to hold the tray in place with respect to the attachment unit by preventing unintended lateral movement of the tray relative to the attachment unit 47.

In addition, in the illustrated embodiment, four positioning pins 53 (three positioning pin 53A and one positioning pin 53B) are provided at positions in the periphery of the positioning shaft portion 51, and in the vicinity of a central front end. The attachment unit 47 is attached to the support unit 31 through the connection mechanism 33 using these four positioning pins 53, and the positioning shaft portion 51.

The attaching plate 49 is a rectangular planar member which is smaller than the main body 65 of the tray 3, and for example, is formed by appropriately folding a metal flat plate material.

The attaching plate 49 is attached with bearing members 81A and 81B for supporting two positioning pins 67A and 67B (two positioning pins 67 are classified by being attached with A and B) which protrude from the mounting surface 24 of the tray 3A. The tray 3A may be mounted on the top face side of the attaching plate 49. Inclined surfaces 81a and 81a which become narrower downward, and guide insertion of the positioning pins 67A and 67B are formed at an opening portion on the insertion side of these bearing members 81A and 81B (two bearing members 81 are classified by being attached with A and B). The fitting holes 48 and 48 are formed in a penetrating state from the lower end portion of these inclined surfaces 81a and 81a to the base of the attaching plate 49.

The above described positioning shaft portion 51 may have a long circular cross-sectional shape with a thick diameter (thicker than the positioning pins 53A). The shaft portion 51 protrudes on the support unit 31 side, at the center of the base of the attaching plate 49 which is attached to the support unit 31.

A base end portion of the positioning shaft portion 51 is supported by the bearing member 83 (FIG. 5). The bearing member 83 is accommodated in the attaching plate 49, and the positioning shaft portion is attached to the attaching plate 49 by tightening a fixing bolt which is inserted from a hole 55 which is formed at the center of the attaching plate 49 on the top face side.

In addition, the three positioning pins 53A which are provided in the periphery of the positioning shaft portion 51 may be short round rod-shaped members having diameters that are smaller than that of the positioning shaft portion 51. A tip end 53a of the positioning pin 53A is processed to be spherical in one example. On the other hand, the positioning pin 53B which is close to the front end of the attaching plate 49 is a longer round rod-shaped member of which a diameter is small (e.g., smaller than the shaft portion 51), and a tip end 53b is processed to be chamfered in one example.

Subsequently, operations of the tray 3A will be described according to a flow of operations from a setting operation of the material to be printed T which is performed using the above described tray 3A and the attachment unit 47 to mounting of the tray 3A with respect to the apparatus main body 2.

### 1. When Performing Setting Operation

The setting operation of the material to be printed T in the tray 3A is performed by placing the tray 3A on a planar portion 69 (FIG. 6) such as a desk, or the like. In this case, the above described attachment unit 47 is provided with the positioning shaft portion 51. The long positioning shaft portion 51 is excluded from the configuration of the tray 3A. In addition, the tray 3A is provided with the leg portion unit 70. In this manner, it is possible to place the tray 3A on the planar portion 69 in a state in which the main body 65 is horizontally supported.

Accordingly, it is not necessary to set the material to be printed T in an unstable posture in which the main body 65 is inclined, and it is possible to set the material to be printed T in a stable posture in which the main body 65 is horizontally supported. Accordingly, it is possible to perform an efficient setting work of the material to be printed T, and to reduce a labor of a worker. The setting operation therefore includes placing the material to be printed in the tray or loading the material in the tray.

The material to be printed T, which is set with respect to the setting surface 23 of the tray 3A in this manner, is positioned at a predetermined setting position, and is inserted between the step portion 59 and the side plate portion 61 of the frame 25 and the edge portion 7 of the tray 3A by inserting the frame 25 from above, and is fixed to the tray 3A.

In addition, prior printing on the material, it is possible to finish the setting work of the plurality of pieces of materials T to be printed in advance by preparing the plurality of trays 3A which are configured as described above. In such a case, the setting work of the material to be printed T, and a fixing work using the frame 25 are repeatedly performed by the number of necessary pieces.

In addition, according to the embodiment, it is possible to treat an end portion of the material to be printed T which protrudes to the outside of the setting surface 23 when performing the setting work which is performed in the periphery of the leg portion 71 without being hindered by the presence of the leg portion 71, by providing the leg portion 71 inside the end edge portion 66 of the tray 3A, and by forming the inclined surface 71a at the outside of the leg portion 71.

In addition, when the material to be printed T such as a T-shirt, or the like is set so as to be put on the main body 65 in a state in which the tray 3A is arranged at the support unit 31 of the ink jet textile printing apparatus, a concern that the material to be printed may be caught by the leg portion 71 when causing the material to be printed to be put on is reduced, and workability is improved.

In addition, main bodies 65 with various sizes using leg portion units 70 having the same configuration can be used, by attaching the leg portion unit 70 by changing an attaching position with respect to trays with different sizes. Accordingly, by communizing the leg portion unit 70, it is possible to reduce a cost of components, and a problem of falsely mounting the leg portion unit 70, which is caused when providing the plurality of leg portion units 70, is reduced.

### 2. When Carrying

When the tray 3A in which the material to be printed T is set in this manner is used, the tray 3A is carried to the support unit 31 of the ink jet textile printing apparatus 1 by holding the grip portion 73 using hands. When the tray is temporarily stored in a storing space or the like, the tray is carried to the storing space.

When the tray 3A is carried, hands are put into the space S which is formed between the grip portions 73 and 73 on the left and right sides and the planar portion 69 (FIG. 6) from the outside, and the grip portions 73 and 73 on the left and right sides are raised upward by being grabbed.

In addition, at this time, since it is configured such that the base 73a side of the grip portion 73 is located at the planar portion 69 side rather than the base 25a of the frame 25, a concern that only the frame 25 may be carelessly held up by hands which act first on the base 25a of the frame 25 is reduced. The frame 25 is supported by the leg units.

In addition, by providing such a grip portion 73, it is possible to easily carry the tray 3A, and to carry the tray 3A to a desired position by reliably holding the tray 3A.

### 3. Mounting Onto Support Unit

The tray 3A, which is carried to the support unit 31 of the ink jet textile printing apparatus 1 in this manner (with the material to be printed set in the tray 3A), is mounted on the attachment unit 47 which is attached to the support unit 31 in the following manner.

The tray 3A, which is carried to the support unit 31 which is present in a setting area by being held at the grip portion 73, causes the two positioning pins 67 and 67 which protrude from the mounting surface 24 of the main body 65 to be fitted or placed or inserted into the fitting holes 48 and 48. The two positioning pins 67 and 67 are inserted into the fitting holes 48 and 48. The fitting holes 48 and 48 are formed on the attaching plate 49 and the positioning pins 67 and 67 are guided by the inclined surfaces 81a and 81a of the bearing members 81 and 81 which are attached to the top face of the attaching plate 49 of the attachment unit 47.

In addition, positioning of the tray 3A with respect to the attachment unit 47 is performed when the two positioning pins 67 and 67 are fitted into the two fitting holes 48 and 48, and a fixing state of the tray 3A with respect to the attachment unit 47 is settled due to the weight of the tray 3A, since the tray 3A itself has a corresponding weight. In other words, the weight of the tray fixes the tray 3A with respect to the attachment unit 47.

Accordingly, the fixing state is also maintained with respect to a movement of the transport unit 17 of the ink jet textile printing apparatus 1, and ink jet printing by the printing unit 19 is performed on the material set in the tray 3A.

As described above, it is possible to carry the tray 3A by holding the two grip portions 73 and 73 using both hands. Accordingly, when carrying the tray 3A in a state in which the material to be printed T is set in the setting surface 23 by holding the tray using hands, it is not necessary to directly grab the material to be printed T tray 3A using hands, by holding the grip portions 73 and 73. In this manner, a force which breaks the set state of the material does not directly act to alter the state of the set material to be printed T, and it is possible to reduce a concern that the set state of the material to be printed T will changed before and after the carrying.

In addition, the protruding dimension of the grip portions 73 and 73 from the mounting surface 24 is the length which exceeds a range in which the frame 25 in a state of being fitted or when attached to the main body is present in the protruding direction. Accordingly, it is possible to prevent only the frame 25 from being held up when hands act on the base of the frame 25 first, when holding up the tray 3A to which the fitted-in frame 25 is attached using hands. In this manner, it is possible to prevent a positional deviation of the material to be printed T which is set in a predetermined position by the frame 25. That is, it is possible to prevent the set state from changing or from being broken.

In addition, since the main body 65 of the tray 3A has a leg portion 71 with a longer protruding dimension than that of the positioning pin 67, it is possible to horizontally place the tray 3A on the planar portion such as a desk by detaching the tray 3A from the support unit 31 of the ink jet textile printing apparatus 1. In this manner, the setting work of setting the material to be printed T in the tray 3A of the ink jet textile printing apparatus 1 becomes easy, and it is possible to perform the setting work efficiently.

In addition, since there is the space S where hands enter on the lower part of the grip portions 73 and 73 in a state in which the main body 65 is raised using the leg portion 71, the operation of holding the grip portions 73 and 73 by hands after ending the setting work becomes easy due to the presence of the space S, and the workability is improved.

In addition, it is possible to perform the work of setting the material to be printed T in the tray 3A in a separate place from the apparatus main body by detaching the tray 3A from the apparatus main body of the ink jet textile printing apparatus 1.

Along with this, when a plurality of sets of tray 3A are prepared, and the material to be printed T is set in these trays 3A in advance, it is possible to omit the setting work of the material to be printed T in a setting area which is performed each time the printing ends, and to efficiently perform efficient the work of setting the material to be printed T and the work of printing on the material to be printed T.

In addition, by integrally forming the grip portion 73 and the leg portion 71, that is, by integrally forming the leg portion unit 70, it is possible to reduce the number of components, and to perform a detaching work, or a adjusting work of changing an attaching position of the grip portion 73 and the leg portion 71 with a small number of processes.

In addition, it is possible to store the tray 3A in a state in which the leg portion unit 70 is detached from the main body 65 when the tray 3A is not used. In this manner, when storing the tray 3A in a state in which the leg portion unit 70 is detached, it is possible to further improve a storing efficiency of the tray 3A, and it is possible to reduce a concern of a loss of an individual component which is caused when the grip portion 73 and the leg portion 71 are set to a single structure as a separate body.

### Description of Tray Accumulation

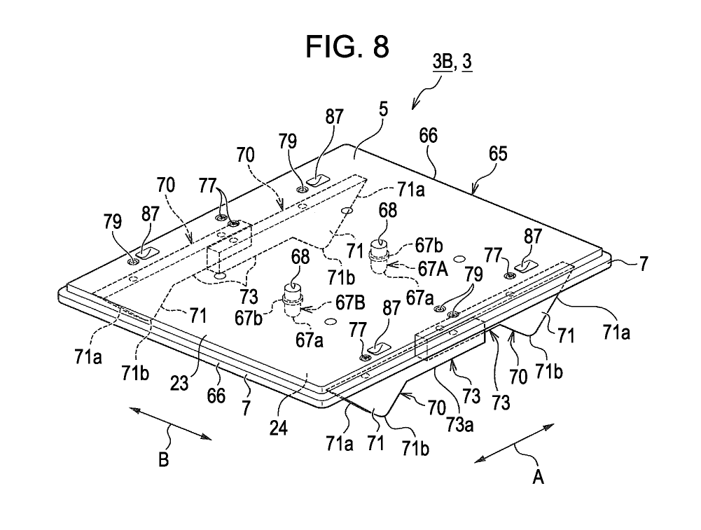

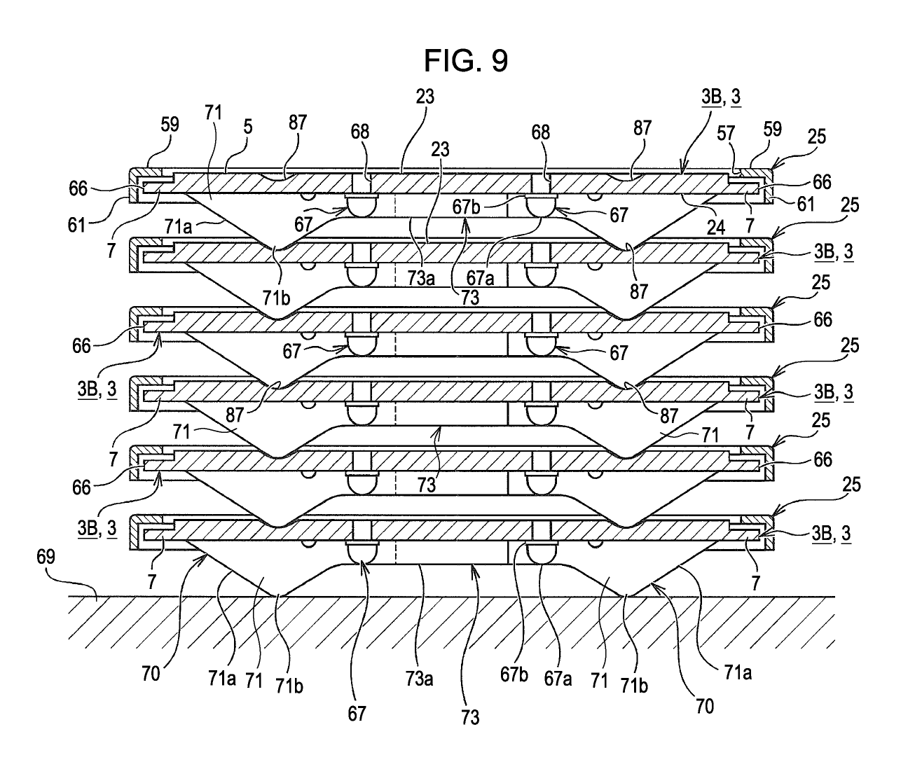

In a tray 3B shown in FIGS. 8 and 9, only a part of a configuration in a main body 65 is different from the tray 3A and other parts of the configuration of the tray 3B are the same.

Accordingly, here, descriptions of the same configurations are omitted, a configuration of the tray 3B, a form of use, and the operation which are executed when using the tray 3B will be described mainly based on the configuration of the main body 65 which is different from the tray 3A.

As illustrated in FIG. 8, the main body includes concave portions that allow the trays to be stacked on top of each other. In FIG. 8, four concave portions 87 are formed and are configured to receive a leg portion 71 of another tray 3B which is accumulated on or placed on the tray 3B. The four concave portions 87 are formed corresponding to the number of leg portions 71 and positions on a setting surface 23 of the main body 65. Here, the shape of the concave portion 87 is formed in a shallow and smooth concave plane so as not to decrease the same smoothness as the setting surface 23 of the main body 65 (in FIG. 8, concave portion 87 is largely illustrated for easy understanding).

The concave portion 87 has the depth in which a tip end portion 71b of the leg portion 71 can be accommodated, and is formed by a concave portion which has the same shape as the tip end portion 71b of the leg portion 71, and is slightly larger than the tip end portion 71b.

The depth of the concave portion 87 has the thickness of the main body 65 or less, since the concave portion is formed on the surface of the tray. In addition, the depth of the concave portion 87 is ½of the thickness of the main body 65 or less in one example, when considering deterioration in strength of the main body 65. In addition, since there is a concern that both of the tip end portion 71b of the leg portion 71 and the concave portion 87 may be sharpened due to a contact with each other depending on the material, the concave portion may be a through hole which penetrates the base of the main body 65. In one example, the concave portions 87 are formed on the outer side of a printing region.

In addition, when using the tray 3B configured in this manner, since the tip end portion 71b of the leg portion 71 of the upper tray 3B is arranged at the concave portion 87 which is formed on the setting surface 23 of the lower tray 3B when the plurality of sets of tray 3B are accumulated or stacked as illustrated in FIG. 9, the accumulated state of the tray 3B or of the stacked trays becomes strong, and aberrations in the position of the tray 3B in each step, or a collapse of the tray 3B is suppressed.

In addition, a storing efficiency of the tray 3B is improved compared to a structure in which accumulation or stacking is not possible, by accumulating or stacking the plurality of sets of tray 3B. Here, the storing efficiency means the number of trays per unit area.

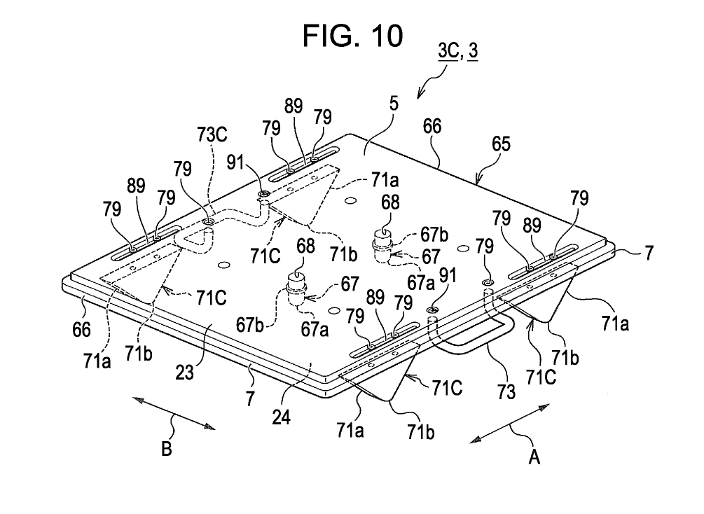

In a tray 3C, as illustrated in FIG. 10, some parts of the configuration of a main body 65, a leg portion 71C and a grip portion 73C are different from the tray 3A, and other portions of the configuration are the same as those previously discussed herein.

Accordingly, here, descriptions of the same configurations are omitted. A configuration of the tray 3B, and operation thereof will be described mainly based on the configurations of the main body 65, the leg portion 71C, and the grip portion 73C.

As illustrated in FIG. 10, the grip portion 73C and the leg portion 71C are configured by separate members and are not integral. The main body 65 of the tray 3 is provided with a long hole 89 which can accommodate adjustment of an attaching position of the leg portion 71C in a predetermined range in the front-back direction instead of the attaching hole 77. The long hole 89 enables the leg portion 71C to be moved in the pre-determined range.

Specifically, the leg portion 71C is configured by a planar member which is triangular in shape when viewed from the side. Screw apertures are formed on the top face of the leg portion 71C. In one example, two screw apertures are formed.

The grip portion 73C is configured to include a handle-like member in which a rod member which is bent in a gate shape protrudes toward the lower part from the mounting surface 24 of the main body 65, and is bent toward the outside on the side in the B direction.

In addition, the main body 65 is formed with an attaching hole 91 for attaching the grip portion 73C to the mounting surface 24 of the main body 65, and the leg portion 71C and the grip portion 73C are attached to a predetermined position on the mounting surface 24 of the main body 65 using a fixed screw 79.

In addition, the same effect as that in the tray 3A is exerted when the tray 3C which is configured in this manner is used. Further, it is possible to adjust an attaching position of the leg portion 71C at a position where a worker comfortably works, and the carrying of the tray 3C becomes easy, since the grip portion 73C becomes easy to grab as the grip portion extends from a side of the tray 3C.

The tray, the ink jet textile printing apparatus, and the manufacturing method of a printed matter according embodiments of the invention are basically configured as described above, however, as a matter of course, it is also possible to performs partial changes in the configuration, omissions, or the like, without departing from the scope of the invention.

For example, the shape, the material, the numbers, and the like of the leg portion 71 are not limited to the configurations which are illustrated in the embodiments discussed herein, and it is possible to adopt various configurations. It is possible to adopt a leg portion 71 of a rectangular block shape, a circular truncated cone shape, a truncated pyramid shape, a columnar shape, a prismatic shape, or the like. In addition, as a material, it is also possible to adopt various materials such as synthetic resin, wood, or a gummy elastic material.

In addition, the number of leg portions 71 is not limited to four, and may be three, or it is possible to provide five or more leg portions. The attaching position of the leg portion 71 is not limited to a peripheral edge portion of the mounting surface 24 of the main body 65, and it is also possible to provide the leg portion 71 inside the peripheral edge portion.

### (1) Number of Leg Portion

For example, the number of leg portions may be adjusted (e.g., in number and/or size) according to a tray size. Specifically, a number of the leg portions is assumed to be increased according to an increase in size of the tray, for example, two leg portions for a small sized tray, three leg portions for a medium sized tray, four leg portions for a large sized tray. When the leg portions number two, a lower end of the leg portion is formed in a planar surface shape so as to be stably raised even with two leg portions. When the tray size increases, the weight of the tray increases according thereto. In such a case, when the tray is neglected for a long time, there is a concern that the tray may be deformed due to its own weight. Therefore, it is possible to suppress the deformation of the tray by increasing the number of leg portions according to the tray size.

When the tray size is small, there is a little concern of deforming of the tray compared to a large tray, since the small tray has a short distance between a center point and an end portion. Accordingly, a small leg portion is provided to a small tray in order to reduce cost, and to prevent an increase in weight.

### (2) Attaching Position of Leg Portion

In addition, in the tray, the deformation of the tray due to its own weight becomes serious at four corner portions which are distant from the center point. Accordingly, by arranging the leg portion at a position which is closer to the corner, it is possible to suppress the deformation of the tray.

### (3) Attaching Method of Leg Portion

According to the above described embodiments, the leg portion 71 is provided in a protruding manner in the same direction as the positioning pin 67 from the mounting surface 24 of the main body 65, however, for example, it may be a configuration in which the leg portion protrudes from the side surface of the main body 65. For example, the leg portion 71 may be screwed to the side surface of the main body 65, and may protrude in the same direction as the positioning pin 67 from the side surface of the main body 65.

In addition, as a material of the main body 65, for example, it is possible to use a transparent synthetic resin flat plate material such as an acrylic plate, however, it is also possible to use an opaque synthetic resin flat material, wood, aluminum flat plate material, or the like. In addition, it is also possible to configure the main body 65 using a composite material in which a strengthened frame of aluminum, or stainless steel is provided in the periphery of the acrylic synthetic resin flat plate, or the like.

Also the shape of the main body is not limited to the rectangular shape according to the embodiments, and some pieces may have a shape of a protruded curved surface, a mountain shape, or the like.

In addition, when the weight of the tray 3 is light, it is also possible to provide a locking unit of a screw type, or a clamp type which fixes the tray 3 on the attachment unit 47 after placing the tray 3 on the attachment unit 47, in order to prevent the tray 3 in the middle of printing from being lifted.

What is claimed is:

1. A tray which is provided so as to be detachable from a support unit of an ink jet textile printing apparatus, comprising:
a main body having a setting surface on which a material to be printed is set;
a first protrusion portion which is used when arranging the main body at the support unit, wherein the first protrusion portion is provided at an opposite side to the setting surface in a protruding manner; and
at least two grip portions provided at the opposite side to the setting surface, wherein the at least two grip portions are separated from each other.

2. The tray according to claim 1,
wherein the at least two grip portions are provided at least at two end portions of the main body which are facing each other.

3. The tray according to claim 1, further comprising:
a frame configured to fit into the main body in a fitted state in which the material to be printed is set on the setting surface, wherein the frame maintains the set state of the material to be printed,
wherein a protruding dimension of the at least two grip portions based on a mounting surface on a side which is opposite to the setting surface is a length which exceeds a range in which the frame in the fitted state is present in the protruding direction.

4. The tray according to claim 1, further comprising:
a leg portion which is provided on a side which is opposite to the setting surface of the main body in a protruding manner, wherein a protruding dimension of the leg portion is longer than a protruding dimension of the first protrusion portion,
wherein a gap that allows hands to be put in is present at a lower part of the grip portion in a state of raising the main body using the leg portion.

5. The tray according to claim 4,
wherein the grip portion and the leg portion are integrally formed.

6. An ink jet textile printing apparatus comprising:
the tray according to claim 1;
a support unit at which the tray is detachably provided; and
a printing unit which ejects ink to the material to be printed which is set in the tray.

7. A manufacturing method of a printed matter comprising:
setting a material to be printed onto a setting surface in a state in which the tray according to claim 4 is raised using the leg portion by being detached from a supporting portion of an ink jet textile printing apparatus;
subsequently carrying the tray by holding the grip portion of the tray using hands;
arranging the tray in the supporting portion; and
executing printing.
